(19) United States
(12) Patent Application Publication
(10) Pub. No.: US 2025/0021358 A1
(43) Pub. Date: Jan. 16, 2025

(54) UNIFYING AND CONNECTING MULTIPLE VIRTUAL DESKTOPS IN A CLIENT WINDOW

(71) Applicant: Omnissa, LLC, Mountain View, CA (US)

(72) Inventors: Lin Lv, Beijing (CN); Yanchao Zhang, Beijing (CN)

(21) Appl. No.: 18/464,697

(22) Filed: Sep. 11, 2023

(30) Foreign Application Priority Data
Jul. 14, 2023 (WO) PCT/CN2023/107425

(51) Int. Cl. G06F 9/451; G06F 3/0486; G06F 3/14

(52) U.S. Cl. CPC G06F 9/452; G06F 3/0486; G06F 3/1454

(57) ABSTRACT

Systems and methods are described providing ways for unifying multiple virtual desktops accessed by a user on a client device in a client window and connecting the virtual desktops to improve efficiency and user experience when the user is working on the multiple desktops. In particular, embodiments described herein leverage a mechanism for detecting when a client device is connected to multiple virtual desktops, combining the graphical user interfaces (GUIs) of the virtual desktops in a client window, and coordinating a connection between the virtual desktops that can be used for enabling various features unifying the desktops such as clipboard redirection to enable copy/paste operations between the desktops and file redirection to allow the desktops to access each other's files and folders.

### CLAIM OF PRIORITY

This application is based upon and claims the benefit of priority from International Patent Application No. PCT/CN2023/107425, filed on Jul. 14, 2023, which is incorporated by reference herein in its entirety.

### TECHNICAL FIELD

The present disclosure generally relates to virtual desktop infrastructure and more specifically to techniques for accessing multiple virtual desktops from one client device.

### BACKGROUND OF THE INVENTION

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a WAN connection. The virtual desktops are typically hosted on servers that reside in a data center of the enterprise or a third-party service provider, and each host server may execute multiple virtual desktops. Users can utilize a client device to remotely log into their individual virtual desktop and all of the application execution takes place on the remote host server which is linked to the local client device over a network using a remote display protocol, such as Remote Desktop Protocol (RDP), PC-over-IP protocol (PCoIP), virtual network computing (VNC) protocol, or the like. Using the remote display protocol, the user can interact with applications of the virtual desktop, which are running on the remote host server, with only the display, keyboard, and mouse information communicated with the local client device. A common implementation of this approach is to host multiple desktop operating system instances on separate virtual machines deployed on a server hardware platform running a hypervisor.

Users often access multiple remote desktops at the same time while performing their work. For example, a user may need to access different remote desktops because each desktop may have different applications, different operating systems, different computing resource configurations, etc. To work on multiple remote desktops, a user would normally connect to each remote desktop from the user's client device so they can perform different tasks on the different remote desktops from the client device. The user may do video-related work on remote desktop A that is configured with a powerful CPU and GPU, do text editing-related jobs on remote desktop B that has document editing software installed, etc.

With the growing popularity of large monitors, users are also able to place multiple remote desktop windows on a single monitor so they can view all the remote desktops on one screen. Nonetheless, using multiple remote desktops still presents several difficulties. For example, switching between different desktop windows, even when they are on one screen, can be inconvenient. Further, each remote desktop is a separate computing environment, and the user may not be able to copy and paste data between different remote desktops or access files on one desktop from another desktop. Accordingly, a user working on remote desktop A would not be able to open a file located on remote desktop B or share clipboards between the remote desktops to copy data (e.g., text, image, file, folder, etc.) from one remote desktop to the other remote desktop. Also, connecting to multiple remote desktops generally incurs high data transfer costs (especially in the case of graphical data and file transfers) because data is transferred between the local device and each of the multiple connected remote desktops, which can consume substantial network bandwidth and hardware resources, particularly when the remote desktops are deployed on a public cloud.

What is needed is a more efficient way for unifying and connecting multiple virtual desktops accessed by a user on a client device.

### BRIEF DESCRIPTION OF DRAWINGS

FIG. 1 illustrates an example of a virtual desktop environment, in accordance with various embodiments.

FIG. 2 illustrates an example architecture of a system for unifying and connecting multiple virtual desktops in a window, in accordance with various embodiments.

FIG. 3A illustrates an example of a client device display where two virtual desktops are presented in separate windows, as was done in previous technology.

FIG. 3B illustrates an example of a client device display where two virtual desktops are presented in one window, in accordance with various embodiments.

FIG. 4 illustrates an example of components in a system for unifying and connecting multiple virtual desktops, in accordance with various embodiments.

FIG. 5A illustrates part 1 of an example swim lane diagram of a process for unifying and connecting multiple virtual desktops, in accordance with various embodiments.

FIG. 5B illustrates part 2 of an example swim lane diagram of a process for unifying and connecting multiple virtual desktops, in accordance with various embodiments.

FIG. 6 illustrates an example of some general components of a computing device, in accordance with various embodiments.

### DETAILED DESCRIPTION OF THE INVENTION

Systems and methods in accordance with various embodiments of the present disclosure overcome at least some of the above-mentioned shortcomings and deficiencies by providing ways for unifying multiple virtual desktops accessed by a user on a client device in a client window and connecting the virtual desktops to improve efficiency and user experience when the user is working on the multiple desktops. In particular, embodiments described herein leverage a mechanism for detecting when a client device is connected to multiple virtual desktops, combining the graphical user interfaces (GUIs) of the virtual desktops in a client window, and coordinating a connection between the virtual desktops that can be used for enabling various features unifying the desktops.

For example, when the user connects to two virtual desktops via a virtual desktop client running on the user's client device, the GUI of each virtual desktop can be streamed to the client from the host server and the client can combine the GUIs (e.g., by placing them next to or on top of each other) in a client window so that the user can view and interact with either desktop from the same client window.

Further, using a connection coordinated between the remote desktops, clipboards can be shared or redirected between the desktops. This way, the user can copy data (e.g., text, images, files, folders, etc.) from one desktop and paste it into the other desktop using copy/paste commands, shortcut keys (e.g., Ctrl+C and Ctrl+V), drag and drop, etc. The copied data can be transferred over the channel connecting the desktops to perform the operation.

Using the connection between the remote desktops, files and folders (e.g., the “Documents” folder) on each remote desktop can be redirected to the other remote desktop so that the user can open and access files and folders of either of the connected remote desktops from within the other connected remote desktop. For example, an app running in one virtual desktop can access files on the other desktop using file redirection.

As a result, a user can use and switch between multiple remote desktops with ease and convenience, and the transfer of data between the desktops for tasks such as copy/paste and file access can be performed efficiently, producing an improved user experience, improved efficiency, and reducing the amount of data transfer between the local and the remote devices, which can significant reduce expenses associated with network bandwidth and hardware resources, particularly in cases where remote desktops are based on a public cloud.

As used throughout this disclosure in the context of remote desktop environments, the terms, “desktop”, “remote desktop”, and “virtual desktop” are used interchangeably and refer to an instance of an operating system and/or applications that run(s) remotely with respect to the user. In a conventional VDI or DAAS environment, each virtual desktop corresponds to a virtual machine (VM) executed on a host server (i.e., a host computing device) that is physically located in a remote datacenter. Each host server may host any number of virtual machines (e.g., tens, hundreds, etc.) and each virtual machine may be owned by an individual user. The virtual machine typically includes a guest operating system (e.g., Windows) capable of executing applications for the user and the virtual machine is used to provide a virtual desktop for the individual user. The user who owns the virtual desktop can remotely log into his or her virtual desktop using a client device that establishes a network connection (e.g., Wide Area Network connection) with the host server and remotely execute various applications on the virtual machine as if the desktop was running on the user's local client device. The client device can be any computing device capable of establishing a network connection, including but not limited to personal computers (PCs), laptops, mobile phones, tablet computers, wearable devices (e.g., smart watches, electronic smart glasses, etc.) or the like.

When a client device is accessing a remote desktop using a remote display protocol (e.g., RDP, PCOIP, VNC, etc.), the graphical user interface (GUI) of the desktop is generated on the server, the GUI image data is then encoded and transmitted over the network to the client device, where it is decoded and displayed to the user. For example, in one embodiment, the framebuffer pixel data on the server is encoded using a codec, such as H264, and transmitted over an Internet connection to the client, where the data is decoded and rendered on a local display screen to the user. Similarly, any user input information, such as keyboard and mouse events, is transmitted from the client device to the server over the network connection, where it may in turn cause various updates to the GUI of the remote desktop. In this manner, the user is able to view the GUI of the remote desktop and interact with it as if the desktop was actually running on the local client device, even though the desktop is actually executing remotely.

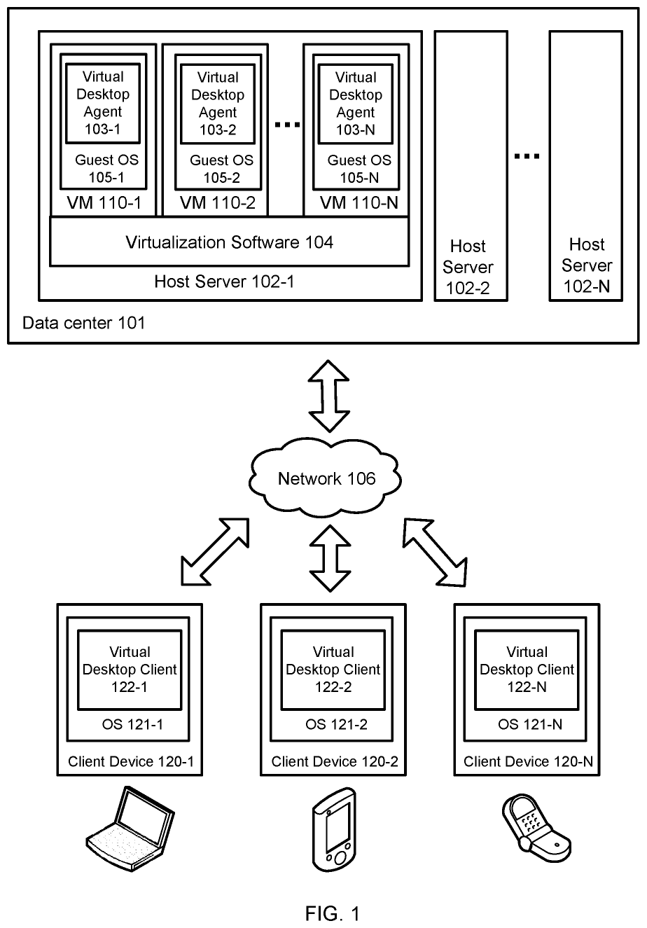

FIG. 1 illustrates an example of a virtual desktop environment, in accordance with various embodiments. The virtual desktop environment, such as VDI or DAAS environment, includes host servers (102-1, 102-2, 102-N) that are communicatively coupled with a number of client devices (120-1, 120-2, 120-N) via a network 106. Network 106 may be a wide area network (WAN), or other form of remote communication link between the host servers (102-1, 102-2, 102-N) and client devices (120-1, 120-2, 120-N). Network 106 may further include numerous other components, such as one or more firewalls, connection brokers, management servers, etc., which are not shown here so as not to obscure salient features of the remote desktop environment. Host servers (102-1, 102-2, 102-N) may physically reside in a data center 101 of the enterprise (e.g., in case of VDI) or in a data center of a third-party service provider (e.g., in case of DAAS).

By way of illustration, host server 102-1 can interoperate with client devices (120-1, 120-2, 120-N) to provide virtual desktop services to users of client devices (120-1, 120-2, 120-N). For example, host server 102-1 can host, for each user, a desktop that is presented by a guest operating system (such as one of the guest operating systems 105-1, 105-2, 105-N) running on a virtual machine (such as one of the virtual machines 110-1, 110-2, 110-N) on host server 102-1. In this context, the terms “desktop”, “remote desktop”, and “virtual desktop” refer to a computing environment in which a user can launch, interact with, and manage the user's applications, settings, and data. Each client device (120-1, 120-2, 120-N) can allow a user to view on a desktop graphical user interface (on a local display device) his/her desktop that is running remotely on host server 102-1, as well as provide commands for controlling the desktop. In this manner, the users of client devices (e.g., 120-1, 120-2, 120-N) can interact with the desktops hosted on host server 102-1 as if the desktops were executing locally on client devices (120-1, 120-2, 120-N).

In the embodiment of FIG. 1, host server 102-1 includes virtualization software 104 that supports the execution of one or more virtual machines (VMs) (e.g., 110-1, 110-2, 110-N). The virtualization software 104 may be a hypervisor, a virtual machine manager (VMM) or other software that allows multiple virtual machines to share the physical resources of the server. In the illustrated embodiment, each virtual machine (e.g., 110-1, 110-2, 110-N) can execute a guest operating system (e.g., 105-1, 105-2, 105-N) that hosts a desktop for a single user at a time. For example, if five users connect to host server 102-1 for the purpose of initiating remote desktop sessions, the host server 102-1 can launch five VMs, each hosting one desktop for each one of the five users. These types of virtual desktop environments where user desktops are hosted within separate, server-side virtual machines are often referred to as virtual desktop infrastructure (VDI) or Desktop-as-a-Service (DAAS) environments.

In such virtual desktop environments, each client device (e.g., 120-1, 120-2, 120-N) can execute a virtual desktop client (e.g., 122-1, 122-2, 122-N). For example, the virtual desktop client (e.g., 122-1, 122-2, 122-N) can be a stand-alone, designated client application (“native client”), or a web browser (“web client”). In some cases, a standard web browser may be modified with a plugin to operate as a web client. The interaction between the virtual desktop and the client device can be facilitated by such a virtual desktop client (e.g., 122-1, 122-2, 122-N) running in the OS (e.g., 121-1, 121-2, 121-N) on the client device (e.g., 120-1, 120-2, 120-N) which communicates with a server-side virtual desktop agent (e.g., 103-1, 103-2, 103-N) that is running on the guest OS inside the virtual machine (e.g., 110-1, 110-2, 110-N). In particular, the interaction can be performed by the virtual desktop agent transmitting encoded visual display information (e.g., framebuffer data) over the network to the virtual desktop client and the virtual desktop client in turn transmitting user input events (e.g., keyboard, mouse events) to the remote desktop agent.

It should be noted that the particular virtual desktop environment illustrated in FIG. 1 is shown purely for purposes of illustration and is not intended to be in any way inclusive or limiting to the embodiments that are described herein. For example, a typical enterprise VDI deployment would include many more host servers, which may be distributed over multiple data centers, which might include many other types of devices, such as switches, power supplies, cooling systems, environmental controls, and the like, which are not illustrated herein. Similarly, a single host server would typically host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the invention.

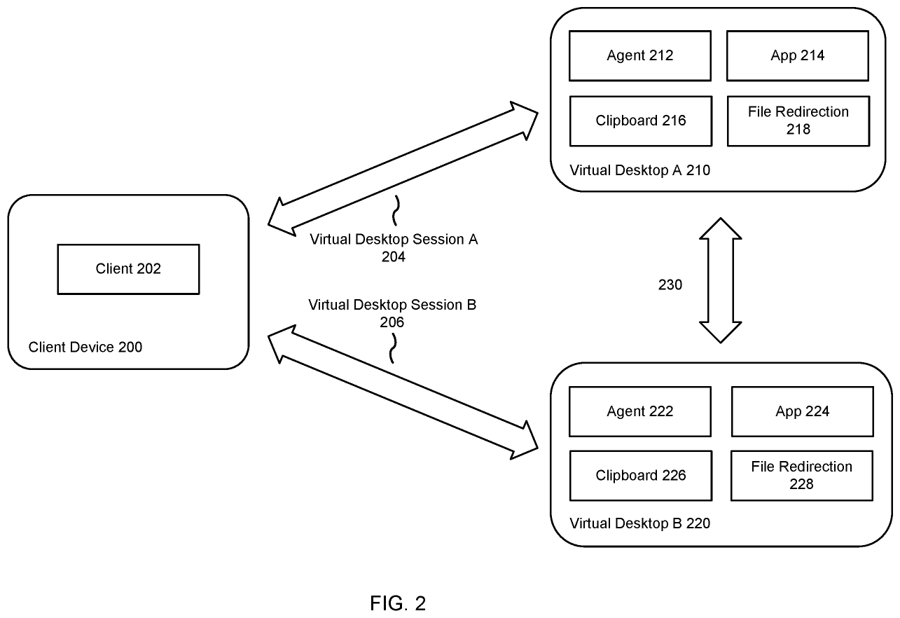

FIG. 2 illustrates an example architecture of a system for unifying and connecting multiple virtual desktops in a window, in accordance with various embodiments. As illustrated in the example of FIG. 2, a client device 200 can connect to two virtual desktops, virtual desktop A 210 and virtual desktop B 220, to access the virtual desktops. In various embodiments, the client device 200 can be a user device such as a laptop, desktop computer, tablet, smartphone, and so on. Virtual desktops A 210 and B 220 can each operate on the same or a different server and connect to the client device 200 over a network connection.

A client 202 (e.g., a virtual desktop client) running on the client device 200 can connect to an agent 212 (e.g., a virtual desktop agent) running in virtual desktop A 210 and establish virtual desktop session A 204, in which a user of the client device 200 can access and interact with virtual desktop A 210. For example, user inputs into desktop A 210 can be sent by the client 202 to the agent 212 to be effectuated in virtual desktop A 210, and the virtual desktop A 210 GUI can be transmitted by the agent 212 to the client 202 to be displayed in a client 202 window on the client device 200. Similarly, the client 202 on the client device 200 can connect to an agent 222 (e.g., a virtual desktop agent) running in virtual desktop B 220 and establish virtual desktop session B 206, in which the user of the client device 200 can interact with virtual desktop B 220. User inputs into desktop B 220 can be sent by the client 202 to the agent 222 to be effectuated in desktop B 220, and the desktop B 220 GUI can be transmitted by the agent 222 to the client 202 to be displayed in a client 202 window on the client device 200.

With previous technology, when a user accessed two virtual desktops on a client device this way, they would generally view each desktop in a separate client window on the client device. However, as discussed above, prior technology presented various inefficiencies and inconveniences for users, and features such as copy/paste and file access were not available between the desktops.

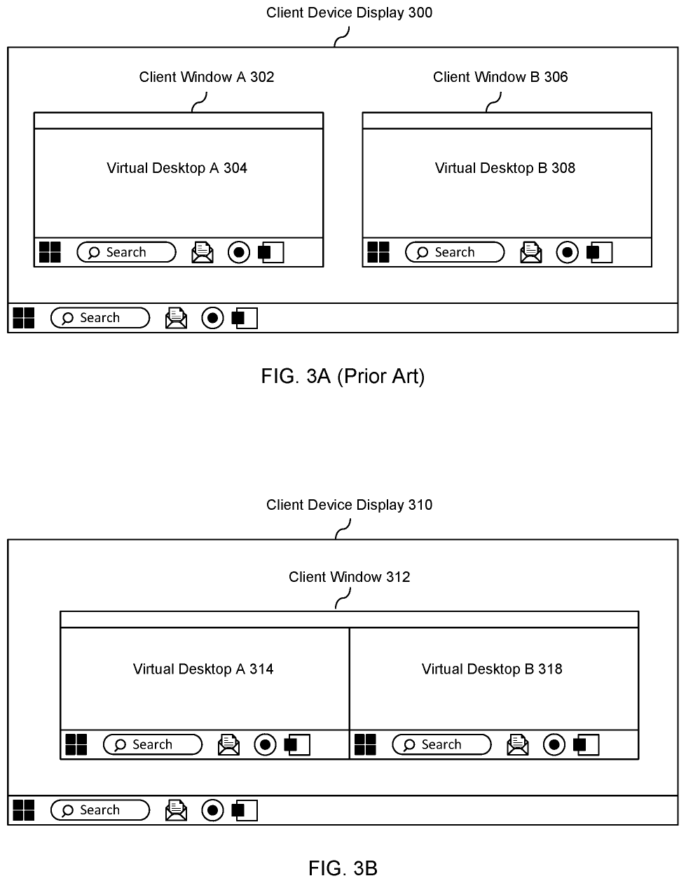

FIG. 3A illustrates an example of a client device display where two virtual desktops are presented in separate windows, as was done in previous technology. As illustrated in the example of FIG. 3A, when a user accessed two virtual desktops on a client device using previous technology, the client device display 300 presented two windows produced by the client (e.g., virtual desktop client), each window corresponding to a different desktop. As illustrated in the example, client window A 302 produced by the client displays the GUI of virtual desktop A 304 and enables the user to interact with desktop A via window A 302. Similarly, client window B 306 produced by the client displays the GUI of virtual desktop B 308 and enables the user to interact with desktop B via window B 306. However, with previous technology the user was not able to copy data from desktop A and paste it into desktop B, or vice versa (e.g., by dragging and dropping a file, using menu commands, keyboard shortcuts, etc.). Also, the user was not able to access files of desktop B in desktop A, and vice versa (e.g., for an application in desktop A to be able to access files located in desktop B). As will be described in further detail below, the various embodiments described herein overcome such shortcomings and provide various other advantages by providing ways for connecting and unifying multiple desktops accessed by the user.

Returning to the example of FIG. 2, when virtual desktop session A 204 and virtual desktop session B 206 are established, the desktop agents 212, 222 can send the GUIs of virtual desktops A 210 and B 220, respectively, to the client 202, and the client 202 can combine or merge the received GUI from desktop A 210 and the received GUI from desktop B 220 and display the GUIs of both desktops in a single window. The client 202 can merge the retrieved graphical data of the received GUIs to produce a single GUI that is displayed in a single window. The client 202 can merge the GUIs in various configurations based on a determined remote display layout (e.g., to arrange them horizontally or vertically). For example, the user can specify how to arrange the GUIs in the window via a user interface (UI) configuration panel. The user can specify whether the GUIs should be side by side or one on top of each other, and which desktop's GUI should be where (e.g., whether the desktop A 210 GUI should be on right or left in the case of a horizontal arrangement, or on top or bottom in the case of a vertical arrangement). The remote display layout can be determined based on such user inputs. The system can also have a default arrangement or remote display layout (e.g., horizontal) in case the user doesn't specify an arrangement for the GUIs. In various embodiments, once a user specifies the arrangement they prefer, the user preferences or the remote display layout can be saved, and whenever the user connects to multiple desktops the client can arrange the multiple desktops in a single window based on the saved information.

In various embodiments, the client 202 can further request each desktop 210, 220 to change its resolution (height, width, etc.) based on the window and the arrangement of the desktop GUIs in the window (e.g., based on the remote display layout). The desktops 210, 220 can then change their resolutions accordingly and send their GUIs with the requested, proper resolution for the client 202 to be able to merge the retrieved graphic data of the GUIs and present the merged GUIs in the window. For example, the client 202 can determine the resolution of the window area where the GUIs are to be displayed and based on the window area and the arrangement of the GUIs in the window, the client 202 can determine the resolution of each GUI and it can request each desktop 210, 220 to change its GUI resolution accordingly.

FIG. 3B illustrates an example of a client device display where two virtual desktops are presented in one window, in accordance with various embodiments. For example, the display illustrated in FIG. 3B can contain GUIs of the virtual desktops 210, 220 described in the example of FIG. 2 that have been horizontally merged by the client 202 on the client device 200. As illustrated in the example of FIG. 3B, the client device display 310 can contain a single window 312 produced by the client, in which both virtual desktop A and virtual desktop B are merged and presented. In this case, the desktops are merged horizontally although in other embodiments they can be merged vertically and in a different right/left or up/down order, as may be specified by the user for example.

As illustrated in the example, the window 312 produced by the client can display the GUI of virtual desktop A 314 on the left side of the window 312, which can also enable the user to interact with desktop A 314. The window 312 can further display the GUI of virtual desktop B 318 on the right side of the window 312, which can also enable the user to interact with desktop B 318.

The user may be able to operate both remote desktops 314, 318 seamlessly in the same window 312, as if they are operating as one remote desktop. In various embodiments, user inputs (e.g., mouse and keyboard events) can be dynamically switched between the remote desktops 314, 318 as the user switches between working on the desktops. User inputs can be conveyed to either virtual desktop A or virtual desktop B depending on the location of the mouse (or the mouse cursor) in the window 312 (e.g., depending on over which desktop the mouse/cursor is positioned). The client can determine whether to send mouse/keyboard events to the first virtual desktop or to the second virtual desktop based on the position of the mouse cursor over the desktop A GUI 314 and the desktop B GUI 318. For example, when the mouse is positioned over remote desktop A 314, the client can send user inputs to remote desktop A 314. The client (e.g., 202) can monitor the position of the mouse (or the mouse cursor) and when it detects that the user moved the mouse from remote desktop A 314 to remote desktop B 318, the client can stop sending the user inputs (mouse and keyboard events) to the remote desktop A agent 212 and begin sending the user inputs to the remote desktop B agent 222.

This way, the client 202 can send the user inputs (mouse, keyboard, etc.) to whichever desktop the user is working on, and the inputs can be effectuated in that desktop. When the user switches to working on desktop A 210, the client 202 can send the user's inputs to the desktop A agent 212, to be effectuated in desktop A 210. When the user switches to desktop B 220, the client 202 can switch to sending the user's inputs to the desktop B agent 222, to be effectuated in desktop B 220. In various embodiments, the client 202 can interoperate with each agent 212, 222 in a similar fashion as the virtual desktop clients and virtual desktop agents described in the example of FIG. 1, except in this case a single client can correspond with multiple agents (e.g., agent 212 and agent 222), as illustrated in the example of FIG. 2.

As mentioned above, with previous technologies, when a user worked on multiple virtual desktops from their client device, as in the example of FIG. 2, various difficulties were present as the user was forced to switch between the virtual desktops to work on applications in different virtual desktops and files and clipboards were not shared by the desktops. Returning to the example of FIG. 2, in various embodiments, to overcome such issues a connection 230 can be established between the virtual desktops 210, 220 over a channel via which data can be exchanged between the desktops 210, 220 to enable various features unifying the desktops.

For example, after the system detects that the client device 200 or the client 202 has connected to (or established virtual desktop sessions with) multiple virtual desktops, e.g., desktop A 210 and desktop B 220, it can coordinate the connection 230 between the desktops (e.g., the client 202 can request one of the desktops to connect to the other). In various embodiments, the channel can be a virtual channel (e.g., per a remote display protocol) connecting the virtual desktops 210, 220. The channel can connect the desktops 210, 220 over a network (WAN, LAN, etc.) or directly, depending on the location of the desktops 210, 220. By having such a connection 230 between the virtual desktops 210, 220, the system can transfer data between the desktops 210, 220 efficiently (e.g., without needing to transfer data (file data, clipboard contents, etc.) through the client device 200).

After the connection 230 between the desktops 210, 220 is established, it can be used to enable various features unifying and connecting the desktops 210, 220.

In various embodiments, the connection 230 can be used to enable clipboard redirection or clipboard sharing between the remote desktops 210, 220, so that content copied from one desktop (e.g., desktop B 220) can be transferred over the connection 230 to be pasted into the other desktop (e.g., desktop A 210), and vice versa. For example, when working in desktop B 220, the user can copy data (e.g., by using shortcut keys (e.g., Ctrl+C), drag and drop actions, via a menu selection, etc.) in desktop B 220 (or in an application 224 running in desktop B 220). Subsequently, the user can produce a paste command in desktop A 210, or in an application 214 in desktop A 210 (e.g., by using shortcut keys (e.g., Ctrl+V), drag and drop, via a menu selection, etc.) to paste the copied content. For example, after copying the data in desktop B 220, the user can switch to desktop A 210 and perform the paste command in desktop A 210.

Returning to the example of FIG. 3B, when working in the virtual desktop B GUI 318, the user can copy data from desktop B (or from an app in desktop B) and paste the data (e.g., by drag and drop, keyboard shortcuts, etc.) into the desktop A GUI 314 (or into an app in desktop A). To perform the paste operation, the copied data can be transferred over the connection 230 from desktop B 220 to desktop A 210 and be pasted into the desktop or an application 214 running in desktop A 210. In the same way, the user can copy data from desktop A 210 and paste it into desktop B 220.

Different approaches can be utilized for coordinating copy/paste operations between desktops. Certain logic and methods can be implemented so that when a user produces a paste command in a desktop, the system can determine what data in either connected desktop (e.g. 210, 220) was last copied and retrieve that data (which may have been copied on either desktop A 210 or desktop B 220) for pasting in response to the paste command. For example, virtual desktops A 210 and B 220 can each contain corresponding clipboards 216, 226, which can be standard components (e.g., in the OS of the desktop) used by applications and the OS of the remote desktop for storing copied data and retrieving data in response to paste commands.

In various embodiments, when a copy command is received on desktop A 210 or B 220, the copied data can be stored in desktop A clipboard 216 or desktop B clipboard 226, respectively. To enable redirection of the clipboards 216, 226 between the desktops 210, 220, when a paste command is received on a desktop, for example on desktop A 210, if the last copy operation was produced on desktop B 220, then the corresponding copied data can be retrieved from the desktop B clipboard 226 and transferred (e.g., over the connection 230) to desktop A 210 to be pasted there. If, on the other hand, the last copy operation was made on desktop A 210, then the corresponding copied data can be retrieved from the desktop A clipboard 216 and pasted in desktop A 210 (which may be the standard copy/paste procedure of the desktop without clipboard redirection).

In an embodiment, clipboard sharing can be implemented by filtering or monitoring requests to the clipboards 216, 226. For example, because a paste request generally results in a query being made to the system clipboard 216, 226 on a desktop, paste requests on the virtual desktops 210, 220 can be detected by monitoring (or filtering) accesses or data requests to the clipboards 216, 226. For example, in various embodiments, a data request can be received at the desktop A clipboard 216 (e.g., by the file system) and in response the system can hang or suspend the request, determine that the last copy operation was performed on virtual desktop B 220, retrieve the copied data from the virtual desktop B clipboard 226 over the channel 230, and return the retrieved data in response to the request. The system can determine whether the last copy operation was performed on virtual desktop B or virtual desktop A in different ways. For example, the system can check both desktops' clipboards 216, 226 to determine which one contains the most recently copied data, it can maintain a universal clipboard that keeps or tracks copied data from either desktop, use a tracking mechanism for determining where the last copy operation took place, etc.

In various embodiments, the channel 230 can be used to redirect files between the remote desktops 210, 220 so that each desktop is able to access files on the other desktop using the connection 230. For example, files, folders, or drives (e.g., the user “Documents” folder) on each connected remote desktop can be redirected to the other remote desktop so that the user can access the redirected files, folders, or drives of either remote desktop on the other connected remote desktop.

With file redirection, applications (e.g., 214) running in virtual desktop A 210 may be able to access files, documents, and data that are stored on virtual desktop B 220. To implement this feature, a file redirection component 218 on virtual desktop A 210 can be utilized that forwards input/output (I/O) requests from virtual desktop A 210 targeting the shared content on virtual desktop B 220 over the connection 230 to a corresponding file redirection component 228 on virtual desktop B 220.

For example, with the file redirection feature, data located on virtual desktop B 220 can be presented in a virtual drive in the virtual desktop A 210. In various embodiments, the system can be configured so that any predefined locations (e.g., directories, files, folders (e.g., the “Documents” folder), drives, etc.) on virtual desktop B 220 are redirected to virtual desktop A 210. The redirected files from desktop B 220 can be presented in a virtual drive in desktop A 210 that is mapped to the corresponding locations of the data on desktop B 220. For example, the virtual drive can be mounted in the file system of desktop A 210 and behave and appear as a normal mounted drive, while inputs and outputs to the virtual drive are redirected (by the file redirection modules 218, 228) to virtual desktop B 220, where the data actually resides. The user can work with the virtual drive in the same way they work with disk drives that are local for the desktop, and applications running in the virtual desktop A 210 can likewise access the virtual drive in the same way as local drives of desktop A 210. When an input/output (I/O) request is produced on virtual desktop A 210 (e.g., by an application in virtual desktop A 210) to the redirected files (e.g., to the mounted virtual drive) on virtual desktop B 220, the file redirection component 218 running in virtual desktop A 210 can forward the I/O request to virtual desktop B 220 over the channel 230. The corresponding file redirection component 228 on virtual desktop B 220 can receive and implement the I/O request, whether by retrieving data and sending the data back to virtual desktop A 210 (e.g., over the connection 230), by writing to a file on virtual desktop B 220, etc. as the case may be.

In the same way, data content (files, drives, folders, etc.) of virtual desktop A 210 can be redirected to virtual desktop B 220, so that the user is able to access the desktop A 210 content while working in desktop B 220, and applications (e.g., 224) running in virtual desktop B 220 are likewise able to access the redirected files located on virtual desktop A 210.

With this solution, the consumption of data transfer resources (especially graphical data and files transfer) between the local and the remote device can be substantially reduced because multiple remote desktops can be displayed within one window and with smaller resolution, and contents on remote desktops (e.g., text/image/file/folder etc.) can be transferred between remote desktops directly, which can save the expense of network bandwidth and hardware resources.

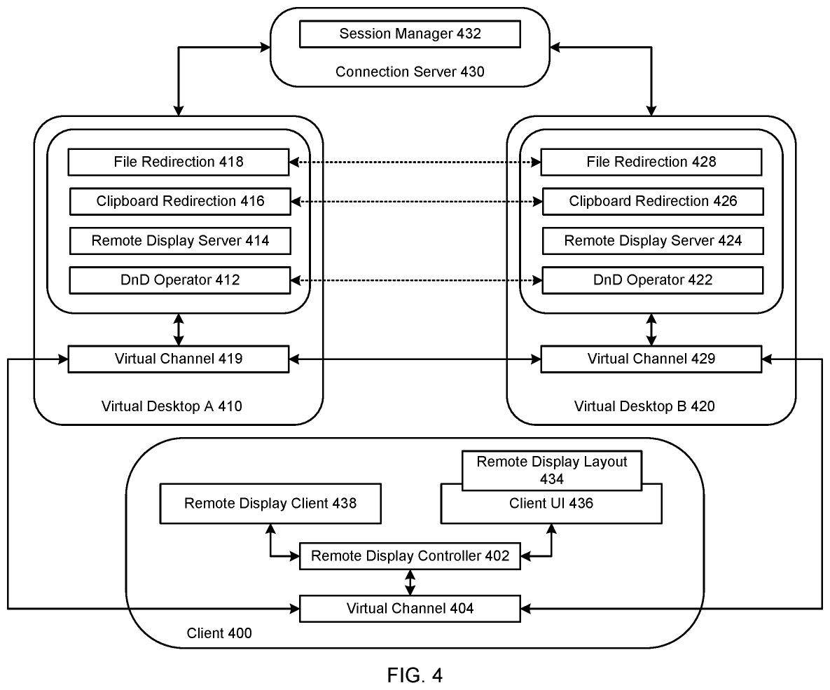

FIG. 4 illustrates an example of components in a system for unifying and connecting multiple virtual desktops, in accordance with various embodiments. The example of FIG. 4 illustrates a client 400, which can be a virtual desktop client installed on a local client device and used by a user to access virtual desktops, such as virtual desktop A 410 and virtual desktop B 420. A connection server 430 can facilitate establishing virtual desktop sessions between the client 400 and remote desktops (e.g., desktop A 410 or desktop B 420). For example, when the user requests the client 400 to connect to a remote desktop (e.g., desktop A 410), the client 400 can send a request to the connection server 430 to connect to desktop A 410. In response to the client request to connect to virtual desktop A 410, the connection server 430 can request a session token from virtual desktop A 410 and return the session token to the client 400. The client 400 can then contact virtual desktop A 410 using the session token to establish a connection and a virtual channel for transferring various data between the local device and virtual desktop A 410. In various embodiments, after the client 400 has connected to virtual desktop A 410 and virtual desktop B 420, the connection server 430 can further facilitate establishing a connection and a channel (e.g., such as the connection 230 between desktop A 210 and desktop B 220 in the example of FIG. 2) between the remote desktops 410, 420 to enable the sharing of data between the desktops 410, 420 for implementing features such as clipboard redirection and file redirection.

As illustrated, the connection server 430 can contain a session manager module 432 responsible for managing virtual desktop sessions and connections between virtual desktops. In various embodiments, the session manager 432 can be produced by modifying and adding functionality as applicable for performing the present invention to a standard session manager used in connection servers of previous technologies (e.g., which was responsible for authenticating clients and managing client-virtual desktop connections in previous technologies). In various embodiments, the session manager 432 can manage the authentication of the client 400 for sessions on virtual desktop A 410 and virtual desktop B 420, the establishing of the virtual desktop sessions and corresponding required connections between the client 400 and the desktops 410, 420, as wells as establishing the connection between desktop A 410 and desktop B 420 for performing clipboard redirection and file redirection between the desktops.

As mentioned, when the system detects that the client 400 is connected to multiple remote desktops (e.g., to virtual desktop A 410 and virtual desktop B 420), it can coordinate a connection between the desktops 410, 420. For example, when the client 400 detects that it has connected to desktop A 410 and to desktop B 420, it can request the desktops 410, 420 to connect to each other. In various embodiments, the client 400 can request the desktop that is active or is currently being used by the user to establish a connection with other remote desktops via the connection server 430. For example, if the user is currently using desktop A 410, then the client 400 can request desktop A 410 to connect to desktop B 420. Desktop A 410 can then send a request to the connection server 430 to connect to desktop B 420. The connection server 430 can first verify the validity of the connection request and then request a session token from desktop B 420 and send the session token to desktop A 410. Desktop A 410 can then communicate with desktop B 420 and establish a connection between the desktops 410, 420 using the obtained session token. The connection can then be used to enable the desktop unifying features described herein (e.g., file and clipboard redirection).

The client 400 can contain a remote display layout module 434, which can be responsible for determining and storing the remote display layout (the arrangement of the desktop GUIs in the window). For example, the remote display layout can define the arrangement of the GUIs relative to each other (side-by-side, on top of each other, etc.). To determine the remote display layout, the remote display layout module 434 can be configured to receive user input on how to arrange the GUIs and it can store a default arrangement that is implemented if the user doesn't provide input. For example, the remote display layout module 434 can be a UI component, which can be part of the client UI 436, that shows the remote display layout to the user and allows the user to modify the layout via this UI. If users don't modify the layout, the remote display layout module 434 can arrange the remote display layout per a default rule. For example, the default rule may be to merge the remote displays of multiple remote desktops horizontally.

In various embodiments, a remote desktop controller module 402 can execute on the client 400 to carry out a controller role including various tasks. The remote desktop controller 402 can monitor and detect when the user (or the client 400) is connecting to multiple remote desktops. When the user connects to multiple remote desktops, the remote desktop controller 402 can first request the remote display layout from the remote display layout module 434 to update the layout or arrangement of the virtual desktop 410, 420 GUIs, and then the remote desktop controller 402 can request a remote display client 438 to work with remote display servers 414, 424 located on remote desktops A 410 and B 420, respectively, to change the remote display of the corresponding desktop GUIs to fit the latest remote display layout change. When the user disconnects one of the remote desktops (e.g., when the user disconnects desktop A 410), this module 402 can again coordinate with the remote display client 438 to work with the remote display server in the other desktop (e.g., remote display server 424) to change the remote display of the remaining connected desktop (desktop B 420) to fit the latest remote display layout, which would for example now include just the GUI of desktop B 420.

When the user connects to the remote desktops 410, 420, the remote desktop controller module 402 can request the remote desktops 410, 420 to establish a connection and virtual channel between the remote desktops 410, 420 so that each remote desktop can transfer data or share files/folders with the other remote desktop to perform functions such as clipboard and file redirection.

In various embodiments, after the desktop 410, 420 GUIs are merged and presented in the client window, when the user tries to drag-and-drop a file from one remote desktop to the other in the window, the remote display controller 402 can work with a DnD (Drag-and-Drop) operator 412, 422 located on either of the remote desktops to determine if the user is attempting to copy and paste the file from one desktop to the other. If the remote display controller 402 determines that the user is attempting to perform the copy and paste operation between the desktops 410, 420, it can forward the DnD (Drag-and-Drop) event information from one remote desktop to the other so that the target remote desktop can handle the DnD event correctly.

When the user disconnects a remote desktop, the remote desktop controller 402 can send requests to either or both remote desktops, as applicable, to terminate the client connection to the disconnected desktop, terminate the data channel connecting the desktops 410, 420 to each other, and terminate the folder mapping established with the disconnected remote desktop.

In various embodiments, the remote display client module 438 in the client 400 can (e.g., after being requested by the remote desktop controller 402) request each remote desktop 410, 420 to set its display (e.g., set the GUI resolution or size) as required by the remote display layout when the user connects to the multiple remote desktops. If the remote display layout is changed (for example, when the user modifies the layout manually or if a new remote desktop is connected or an existing remote desktop is disconnected), the remote display client 438 can communicate with the remote display servers 414, 424 on the remote desktops to change the remote display based on the latest or updated remote display layout.

The remote display client module 438 can retrieve the graphical data of the remote displays from the remote desktops 410, 420 and merge the remote display according to the remote display layout for the multiple remote desktops. The remote display client module 438 can then display the finalized remote display containing the GUIs of both desktops 410, 420 within one window.

In various embodiments, the remote display server 414, 424 in each remote desktop 410, 420 can operate to configure the GUI of the corresponding desktop, for example, to set the display resolution, DPI, or other settings related to the remote display in the operating system (OS) of the corresponding virtual desktop 410, 420, as may be required by the client 400. The remote display server 414, 424 can modify the display resolution of its corresponding desktop 410, 420 to fit requirements based on the remote display layout when the user connects to multiple remote desktops. The remote display servers 414, 424 can send the graphical data of the desktop 410, 420 remote displays to the client side so that the client 400 can display the graphical data to the user in the client window.

Different approaches can be utilized to detect when the user is attempting to drag and drop a file from one desktop (e.g., from desktop A 410) to another desktop (e.g., desktop B 420) in the client window and to perform the corresponding drag and drop operation. In various embodiments, the system can detect when the user picks up a file in virtual desktop A 410 (with the mouse cursor) and moves the mouse while holding the file (e.g., without releasing the mouse) to virtual desktop B 420 and releases the mouse. The system can then perform the paste operation.

For example, virtual desktop A 410 can monitor mouse activity in the GUI of desktop A 410 (e.g., via a component such as the DnD operator 412). The desktop 410 can detect when the user picks up a file with the mouse cursor and moves or drags it to a border of the virtual desktop 410 GUI without releasing the mouse. Desktop A 410 can notify (e.g., by sending a message) the client 400 of this event (and provide various event information for performing a drag and drop operation of the file). Once the client 400 is notified of the event, if can determine, based on the remote display layout, if the mouse cursor is released by the user (subsequently to picking up the file in desktop A 410) in desktop B 420 (thereby indicating that the user is attempting to drag the file out of desktop A 410 and drop it into desktop B 420). If the client 400 determines that the user is trying to drag and drop the file into desktop B 420 (e.g., it detects that that the mouse cursor is subsequently released in the virtual desktop B GUI, based on the remote display layout), it can trigger a process for transferring and pasting the file into virtual desktop B to produce the drag and drop operation.

As mentioned, the remote desktops 410, 420 can each contain a DnD operator module 412, 422 for managing drag-and-drop operations between the desktops in the window. In various embodiments, the DnD Operators 412, 422 can work with the remote display controller module 402 on the client 400 side to perform drag-and-drop operations of files from one remote desktop to the other. For example, when the user drags a file (e.g., by clicking on it, holding it, and moving it) on one remote desktop, e.g., desktop A 410, to the desktop 410 border, the DnD operator module 412 on the desktop 410 can detect this drag event and send the event to the remote display controller 402. (The DnD operator 412 can wait for the file to remain on the border for a predetermined period of time (e.g., one second) to ensure that the user didn't drag the file to the border by accident, for example). The sent event can include information such as: filename, file type, file icon position on the remote desktop 410, etc. The remote display controller 402 on the client 400 can receive this event with the event information and check if the user is trying to drag the file to the other remote desktop 420 based on the remote display layout. (e.g., the remote display controller 402 can check if the user has moved the mouse cursor to the region of the other desktop in the window). If the remote display controller 402 determines that the user is trying to drag the file to the other remote desktop 420, the remote display controller 402 can forward this event and the event information to the target remote desktop that can then create a fake file icon based on the event info so that the user can continue to drag the file (and see the icon) onto the target remote desktop. Meanwhile, the target remote desktop can notify the source remote desktop to release the drag action on it since the user has been dragging the file icon to the target remote desktop. Once the user releases the mouse (e.g., releases the mouse button) on the target remote desktop, the file on the source remote desktop can be transferred to the target remote desktop and the file on the source remote desktop can be removed.

In various embodiments, the desktops 410, 420 can contain corresponding clipboard redirection modules 416, 426, which can perform the transferring of clipboard data between the remote desktops 410, 420 so that the user can copy/paste content between the desktops as described previously.

In various embodiments, the desktops 410, 420 can contain corresponding file redirection modules 418, 428, which can correspond with each other to redirect files between the desktops 410, 420, as described previously. For example, when the user connects to multiple desktops (e.g., to desktops A 410 and B 420), the user's files (e.g., the “My Documents” folder) on each remote desktop can be redirected (or mapped) to the other connected remote desktop by the file redirection modules 418, 428 operating on each desktop, so that either connected desktop can access files on the other connected desktop.

In various embodiments, virtual channels (e.g., protocol virtual channels) can be implemented for data transfer between the client device and remote desktops. As illustrated, the client 400 in the client device can contain a virtual channel module 404 that can manage communications over a virtual channel established with corresponding virtual channel modules 419, 429 in virtual desktops A and B, respectively. In various embodiments, virtual channel modules 419, 429 in virtual desktops A and B can contain additional functionality allowing the virtual channel module 419 in desktop A 410 to establish a virtual channel with the virtual channel module 429 in desktop B 420 for transferring data between the desktops for enabling the features discussed herein unifying the desktops, such as file and folder redirection, and clipboard redirection. For example, the virtual channel established between the virtual channel modules 419, 429 can be used by the clipboard redirection modules 416, 426, and the file redirection modules 418, 428 to communicate with each other.

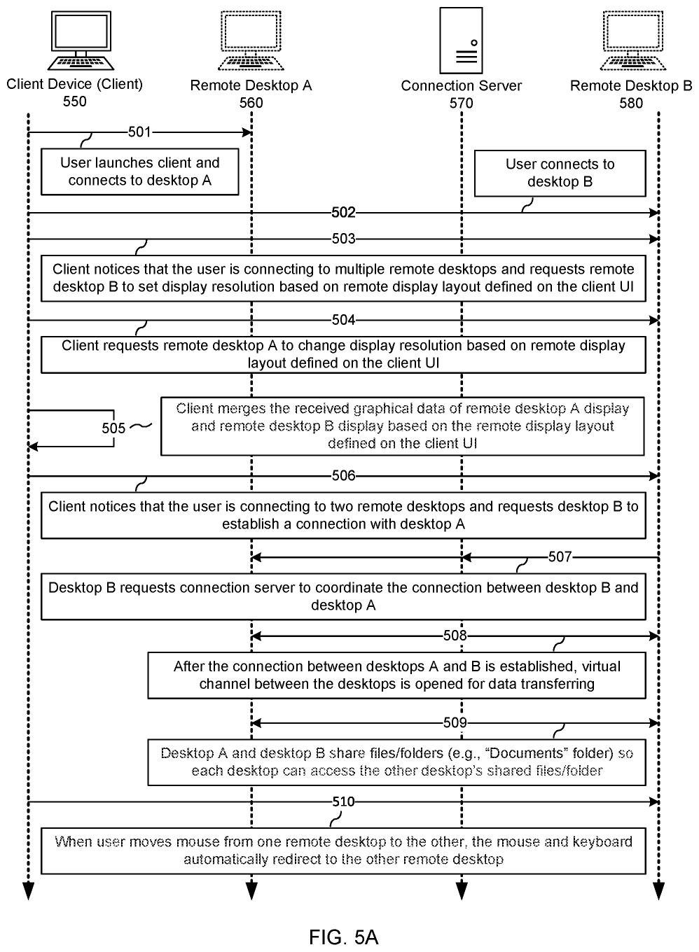

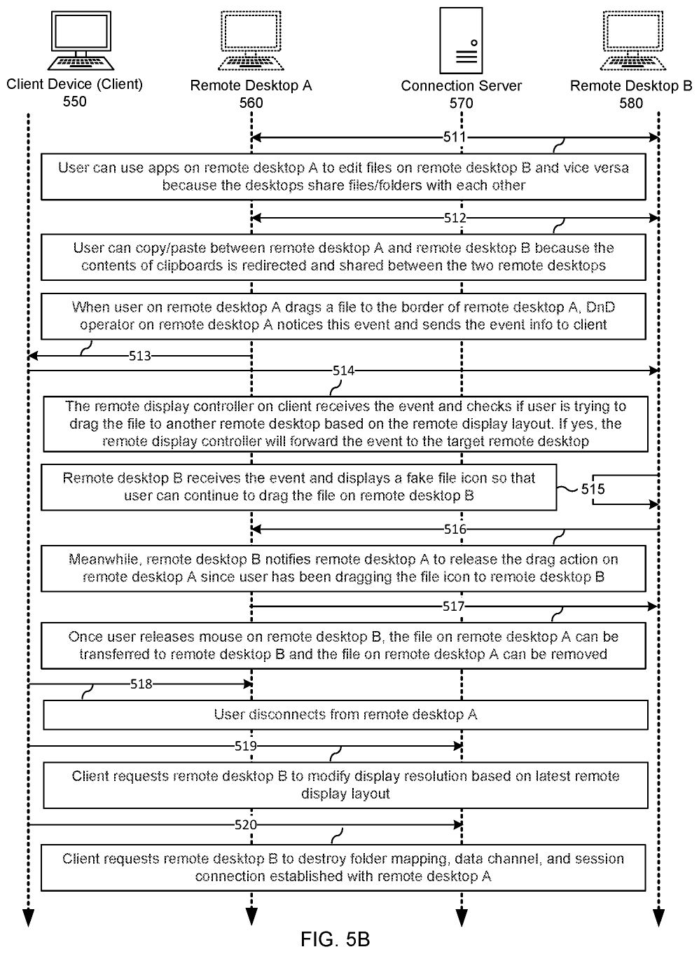

FIG. 5A illustrates part 1 of an example swim lane diagram of a process for unifying and connecting multiple virtual desktops, in accordance with various embodiments. The process can begin in operation 501, where the user can launch a client (e.g., a virtual desktop client) on a client device 550 and connect the client to remote desktop A 560. In operation 502, the user can connect the client to remote desktop B 580. In operation 503, the client can notice that the user is connecting to multiple remote desktops and request remote desktop B to set display resolution based on the remote display layout defined on the client UI. For example, to determine the remote display layout, the client UI can allow the user to provide an arrangement for the desktop (horizontal, vertical, etc.) or a default arrangement can be used if the user does not indicate a preference. Based on the defined remote display layout, the client can then determine the required resolution of remote desktop B and request remote desktop B to set its display resolution accordingly. Then, in operation 504, the client can similarly request remote desktop A to set its display resolution based on the remote display layout defined on the client UI.

After remote desktops A and B 560, 580 set their display resolution as requested by the client and convey the graphical display data (e.g., the GUIs) to the client, in operation 505, the client can merge the received graphical data of the remote desktop A display and the remote desktop B display based on the remote display layout defined on the client UI. The merged displays (GUIs) of desktop A and B can then be presented in a client window on the client device 550.

In operation 506, after noticing that the user is connecting to the two remote desktops, the client can request desktop B to establish a connection with desktop A (e.g., to enable features such as clipboard and file/folder redirection). In response to the request, in operation 507, desktop B can send a request to a connection server 570 to coordinate the connection between desktop B and desktop A, and the connection server can coordinate such a connection. In operation 508, after the connection between desktops A and B is established, a virtual channel between the desktops can be opened for data transferring.

Using the connection and virtual channel for transferring data between the desktops, in operation 509, desktop A and desktop B can share files/folders (e.g., “Documents” folder) so each desktop can access shared files/folders on the other desktop. For example, certain files, folders, drives, etc. can be redirected from each desktop to the other desktop and presented in a virtual drive, as discussed previously.

In operation 510, when the user moves the mouse from one remote desktop to the other, the mouse and keyboard can be automatically redirected to the other remote desktop. For example, when the displays of both desktops are presented in the client window, if the user is working in desktop A 560 in the client window and has their mouse in desktop A, the client can send user inputs (e.g., mouse and keyboard events) to desktop A 560 (e.g., to the agent in desktop A) to be implemented in desktop A. If the user then moves the mouse from desktop A to desktop B in the window, the client can detect that the mouse (e.g., the cursor) has moved to desktop B and in response stop sending the user input events to desktop A and instead send them to desktop B (e.g., to the desktop B agent) to be effectuated in desktop B. The process then continues in FIG. 5B.

FIG. 5B illustrates part 2 of an example swim lane diagram of a process for unifying and connecting multiple virtual desktops, in accordance with various embodiments. Continuing from FIG. 5A, in operation 511, the user can use applications on remote desktop A to edit files on remote desktop B and vice versa because the desktops share files/folders with each other via file/folder redirection. In operation 512, the user can copy/paste between remote desktop A 560 and remote desktop B 580 because the content of clipboards is redirected and shared between the two remote desktops.

In operation 513, when the user working on remote desktop A drags a file to the border of remote desktop A, the DnD operator on remote desktop A can notice this event and send the event information to the client. The DnD operator can wait for the dragged file to stay on the border for a second or another predetermined period of time before sending the event to ensure that the user is intending to drag the file out of desktop A. In operation 514, the remote display controller on the client can receive the event sent by the DnD operator and check if the user is trying to drag the file to another remote desktop based on the remote display layout. If the remote display controller determines that the user is trying to drag the file to the other remote desktop (desktop B 580), the remote display controller can forward this event to the target remote desktop (desktop B 580). In operation 515, remote desktop B can receive the event and display a fake file icon so that the user can continue to drag the file on remote desktop B. Meanwhile, in operation 516, remote desktop B can notify remote desktop A to release the drag action on remote desktop A since the user has been dragging the file icon to remote desktop B. Then, in operation 517, once the user releases the mouse on remote desktop B, the file on remote desktop A can be transferred to remote desktop B (e.g., over the connection between desktops A and B) and the file on remote desktop A can be removed.

In operation 518, the user can disconnect from desktop A. In operation 519, the client can request remote desktop B to modify its display resolution based on the latest remote display layout (e.g., the remote display layout can now contain just desktop B in the window because desktop A is disconnected). In operation 520, the client can request remote desktop B to destroy the folder mapping, data channel, and session connection established with remote desktop A.

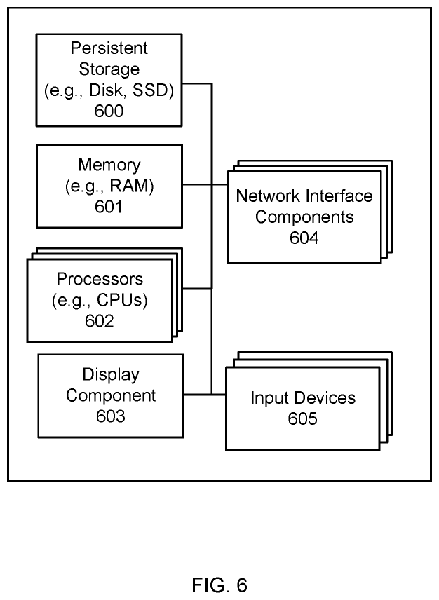

FIG. 6 illustrates an example of some general components of a computing device, in accordance with various embodiments. In this particular example, the device includes one or more processors (e.g., central processing units (CPUs) 602 for executing instructions that can be stored in a storage medium component. The storage medium can include many types of memory, persistent data storage, or non-transitory computer-readable storage media. For example, the storage medium may take the form of random access memory (RAM) 601 storing program instructions for execution by the processor(s) 602, a persistent storage (e.g., disk or SSD) 600, a removable memory for sharing information with other devices and/or the like. The computing device typically can further comprise a display component 603, such as a monitor, a touch screen, liquid crystal display (LCD), or the like. In various embodiments, the computing device will include at least one input device 605 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 604 for communicating over various networks, such as a Wi-Fi®, Bluetooth®, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method, comprising:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
receiving a first graphical user interface (GUI) of the first virtual desktop at the client device;
receiving a second GUI of the second virtual desktop at the client device;
determining a remote display layout corresponding to an arrangement of the first GUI and the second GUI together in a window; and
based on the determined remote display layout, presenting the first GUI and the second GUI together in the window on the client device.

2. The method of claim 1, wherein the virtual desktop client determines whether to send user input events to the first virtual desktop or to the second virtual desktop based on the position of a mouse cursor over the first GUI and the second GUI in the window.

3. The method of claim 1, further comprising:
establishing a connection between the first virtual desktop and the second virtual desktop for exchanging data between the first virtual desktop and the second virtual desktop; and
using the connection between the first virtual desktop and the second virtual desktop, performing at least one of:
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

4. The method of claim 3, wherein redirecting the file from the first virtual desktop to the second virtual desktop comprises presenting a virtual drive mounted in the second virtual desktop that is mapped to the first virtual desktop.

5. The method of claim 1, further comprising:
detecting by the virtual desktop client the first virtual desktop session and the second virtual desktop session are established and, in response to detecting that the multiple virtual desktop sessions are established, requesting one of the virtual desktops to establish a connection with the other virtual desktop.

6. The method of claim 1, further comprising:
in the first virtual desktop, detecting that a file is picked up by a mouse cursor and moved to a border of the first virtual desktop GUI without being released;
detecting on the client device, based on the remote display layout, that the mouse cursor is subsequently released in the second virtual desktop GUI; and
in response to determining that that the mouse cursor is subsequently released in the second virtual desktop GUI, pasting the file into the second virtual desktop.

7. The method of claim 1, further comprising:
based on the remote display layout, determining a resolution for the first GUI and requesting the first virtual desktop to set its GUI to the determined resolution for the first GUI; and
based on the remote display layout, determining a resolution for the second GUI and requesting the second virtual desktop to set its GUI to the determined resolution for the second GUI.

8. A computing device, comprising:
at least one processor; and
memory including instructions that, when executed by the at least one processor, cause the computing device to perform the steps of:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
receiving a first graphical user interface (GUI) of the first virtual desktop at the client device;
receiving a second GUI of the second virtual desktop at the client device;
determining a remote display layout corresponding to an arrangement of the first GUI and the second GUI together in a window; and
based on the determined remote display layout, presenting the first GUI and the second GUI together in the window on the client device.

9. The computing device of claim 8, wherein the virtual desktop client determines whether to send user input events to the first virtual desktop or to the second virtual desktop based on the position of a mouse cursor over the first GUI and the second GUI in the window.

10. The computing device of claim 8, wherein the memory further includes instructions that when executed by the at least one processor, cause the computing device to perform the steps of:
establishing a connection between the first virtual desktop and the second virtual desktop for exchanging data between the first virtual desktop and the second virtual desktop; and
using the connection between the first virtual desktop and the second virtual desktop, performing at least one of:
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

11. The computing device of claim 10, wherein redirecting the file from the first virtual desktop to the second virtual desktop comprises presenting a virtual drive mounted in the second virtual desktop that is mapped to the first virtual desktop.

12. The computing device of claim 8, wherein the memory further includes instructions that when executed by the at least one processor, cause the computing device to perform the steps of:
detecting by the virtual desktop client the first virtual desktop session and the second virtual desktop session are established and, in response to detecting that the multiple virtual desktop sessions are established, requesting one of the virtual desktops to establish a connection with the other virtual desktop.

13. The computing device of claim 8, wherein the memory further includes instructions that when executed by the at least one processor, cause the computing device to perform the steps of:
in the first virtual desktop, detecting that a file is picked up by a mouse cursor and moved to a border of the first virtual desktop GUI without being released;
detecting on the client device, based on the remote display layout, that the mouse cursor is subsequently released in the second virtual desktop GUI; and
in response to determining that that the mouse cursor is subsequently released in the second virtual desktop GUI, pasting the file into the second virtual desktop.

14. The computing device of claim 8, wherein the memory further includes instructions that when executed by the at least one processor, cause the computing device to perform the steps of:
based on the remote display layout, determining a resolution for the first GUI and requesting the first virtual desktop to set its GUI to the determined resolution for the first GUI; and
based on the remote display layout, determining a resolution for the second GUI and requesting the second virtual desktop to set its GUI to the determined resolution for the second GUI.

15. A non-transitory computer readable storage medium comprising one or more sequences of instructions, the instructions when executed by one or more processors causing the one or more processors to execute the operations of:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
receiving a first graphical user interface (GUI) of the first virtual desktop at the client device;
receiving a second GUI of the second virtual desktop at the client device;
determining a remote display layout corresponding to an arrangement of the first GUI and the second GUI together in a window; and
based on the determined remote display layout, presenting the first GUI and the second GUI together in the window on the client device.

16. The non-transitory computer readable storage medium of claim 15, wherein the virtual desktop client determines whether to send user input events to the first virtual desktop or to the second virtual desktop based on the position of a mouse cursor over the first GUI and the second GUI in the window.

17. The non-transitory computer readable storage medium of claim 15, further comprising instructions that when executed by the one or more processors cause the one or more processors to execute the operations of:
establishing a connection between the first virtual desktop and the second virtual desktop for exchanging data between the first virtual desktop and the second virtual desktop; and
using the connection between the first virtual desktop and the second virtual desktop, performing at least one of:
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

18. The non-transitory computer readable storage medium of claim 17, wherein redirecting the file from the first virtual desktop to the second virtual desktop comprises presenting a virtual drive mounted in the second virtual desktop that is mapped to the first virtual desktop.

19. The non-transitory computer readable storage medium of claim 15, further comprising instructions that when executed by the one or more processors cause the one or more processors to execute the operations of:
detecting by the virtual desktop client the first virtual desktop session and the second virtual desktop session are established and, in response to detecting that the multiple virtual desktop sessions are established, requesting one of the virtual desktops to establish a connection with the other virtual desktop.

20. The non-transitory computer readable storage medium of claim 15, further comprising instructions that when executed by the one or more processors cause the one or more processors to execute the operations of:
in the first virtual desktop, detecting that a file is picked up by a mouse cursor and moved to a border of the first virtual desktop GUI without being released;
detecting on the client device, based on the remote display layout, that the mouse cursor is subsequently released in the second virtual desktop GUI; and
in response to determining that that the mouse cursor is subsequently released in the second virtual desktop GUI, pasting the file into the second virtual desktop.
